(19) United States
(12) Patent Application Publication
(10) Pub. No.: US 2008/0099964 A1
(43) Pub. Date: May 1, 2008

(54) Thermoformed nursery container with a defined rim

(75) Inventors: Joseph A. Guarriello, Boiling Springs, PA (US); Robert Cook, Chambersburg, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Nursery Supplies, Inc.

(21) Appl. No.: 11/799,627

(22) Filed: May 2, 2007

Related U.S. Application Data
(60) Provisional application No. 60/854,646, filed on Oct. 26, 2006.

(51) Int. Cl. B29C 43/02

(52) U.S. Cl. 264/544; 428/35.7

(57) ABSTRACT

A method of thermoforming a container with a well-defined rim, and the container produced thereby. The rim surfaces are defined during the thermoforming process by the surfaces of the mold. The resulting container features a stiffer, stronger rim that is easier to grasp when carrying the container.

### RELATED APPLICATION

The present invention is related to and claims priority from U.S. Provisional Patent Application No. 60/854,646 filed Oct. 26, 2006, which is incorporated herein by reference in its entirety.

### FIELD OF THE INVENTION

The present invention relates to nursery containers and, more particularly to a thermoformed nursery container with a defined rim.

### BACKGROUND

Over the years, nursery containers have been made from various materials, including metal and wood, and a number of different processes. In recent years nursery containers have almost exclusively been manufactured from plastic, due to its low cost, lightweight construction, and mass production capability.

The three primary plastic manufacturing processes for making plastic containers are injection molding, blow molding, and thermoforming. Each of these processes has its benefits and deficiencies. Injection molding, which involves injecting molten material between two closed mold halves, results in a strong and rigid container. The primary drawback to injection molding is that the molding process involves slow cycle times and produces a product that has a higher overall material weight than products molded from other processes. The long cycle time and higher weight results in higher costs per part.

Blow molding involves pressurizing a parison of plastic material to cause it to expand or “blow” against the walls of a mold. A blow molding process results in a lightweight container and has lower cycle times. As such, a blow molded container is considerably less expensive to manufacture than an injection molded container. The primary deficiency with a blow molded container is the lack of structural rigidity in the resulting container.

Thermoforming is one of the more recent molding methods for forming containers. Thermoforming involves use of a plug to deform a sheet of material into a mold cavity. Pressure and vacuum is used to force the sheet material to conform to the contour of the mold. The result is a container that is more rigid than conventional blow molded containers, and weighs less (and is less expensive) than an injection molded container. However, thermoformed containers lack rigidity in the lip of the container.

One conventional thermoforming process is shown in FIGS. 1A-1G. A mold assembly 1 includes a lower mold 2 with an inner cavity. An interior surface 3 within the lower mold includes a contour that defines the outside of the finished container. The mold assembly also includes an upper clamp plate 4 that includes a clamp ring 5.

In the first step of the process, the clamp plate is separated from the mold. A sheet 6 of hot plastic material is placed on the top surface of the mold. See FIG. 1A. The clamp plate 4 is brought into contact with the sheet 6 by, for example, lowering the clamp plate. The lowering of the clamp plate brings the clamp ring 5 into registry with a moat or recess ring 7 formed in the top surface of the mold, thereby clamping and sealing the sheet in place. See FIGS. 1B and 1C.

A plug assist 8 is brought down through clamp plate 4 and into contact with the plastic sheet. The plug assist mechanically forces the sheet into the mold, causing the sheet to stretch. See FIG. 1D.

After the plug assist 8 is completely lowered, pressurized air 9 is introduced into inside of the sheet, while a vacuum 10 is drawn on the outside of the sheet. The combination of the internal pressure and external vacuum draws the plastic sheet into contact with the interior surface of the mold, causing the plastic to cool and solidify. See FIGS. 1E and 1F.

Due to the thickness of the sheet material, the plastic does not form a well defined contour, especially in tight crevices such as ridges or steps. Instead, the material tends to smoothly transition around corners or edges. See FIGS. 1F and 1I. While this may be visually pleasing, it impairs the rigidity of the container. Also, the inability to create tight, well formed corners, especially near the top of the container, makes the nesting of the containers less precise and can lead to sticking together of containers.

Another problem is that ridges cannot be formed on the inside rim of the container using a thermoforming process. More specifically, because a thermoforming process uses air and vacuum to force the material onto the inside surface of a mold, only the outside of a thermoformed container has, to date, been defined by a mold. The shape and contour of the inside surface of the container simply results from blowing and suctioning the plastic on the inside of the mold. Therefore, the inside surface is generally smooth.

A smooth interior surface of a container is difficult to grasp since it lacks frictional characteristics. In conventional injection molded containers, it is possible to formed rings or ridges on the inside of the container rim because an interior mold is used in such a process. Thermoforming does not have an interior mold and thus conventional thermoformed containers have only had smooth interior surfaces around the rim.

In some conventional thermoforming processes, a coining ring is used instead of a clamp ring secure the outer edge of the plastic sheet prior to molding. FIGS. 1G and 1H illustrate the prior use of a coining ring. In such a typical process, the ring clamps down on and secures the sheet material along the outer radial side of the container. This does not assist in creating any unique and defined molding features inside the rim.

A need exists for an improved thermoformed container that has a more defined rim.

### BRIEF SUMMARY OF THE INVENTION

The present invention provides a method for thermoforming a container with a well-defined rim, and the container made by such a method. The method provides that the container rim is formed by a coining ring attached to an upper mold, and a lower mold surface. In this method, the coining ring acts as an inner mold for the rim. The remaining portion of the container is formed through the thermoforming process. The mold surfaces may contain contours or other features the manufacturer wishes to create on the rim, including stiffening ribs or frictional ridges to assist in grasping and carrying the finished container. The rim features well-defined edges and corners, which not only allow the rim to be stiffer than typical thermoformed rims, but also aid in storage of multiple containers by providing well-defined contact surfaces for nested, stacked containers.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIGS. 1A-1F are a series of cross-sectional views of the inside of the mold assembly illustrating the manufacturing process of a convention thermoformed container. FIGS. 1G and 1H illustrate the prior use of a coining ring in a thermoforming process. FIG. 1I is an enlarged cross-section illustrating a rim on a conventional thermoformed container. FIG. 1J is an enlarged cross-section illustrating a rim on a conventional thermoformed container with a molded stiffening rib.

FIG. 2 is a cross-sectional view of the inside of the mold assembly according to the present invention with the mold assembly in the open position.

FIG. 3 is a cross-sectional view of the inside of the mold assembly of FIG. 2 with the mold assembly in the closed position prior to the thermoforming operation.

FIG. 4 is an enlarged view taken from FIG. 3 and showing the clamped molds prior to the thermoforming process.

FIG. 5 is a cross-sectional view of the inside of the mold assembly of FIG. 2 with the mold assembly in the closed position and with the plug assist forming the sheet into a preform.

FIG. 6 is a cross-sectional view of the inside of the mold assembly of FIG. 2 with the mold assembly in the closed position after pressure and vacuum forming of the sheet onto the mold interior surface.

FIG. 7A is an enlarged cross-section of the rim of a finished thermoformed container according to the present invention.

FIG. 7B is an enlarged cross-section of the rim of a finished thermoformed container according to the present invention illustrating an optional molded in stiffening rib.

### DETAILED DESCRIPTION OF THE DRAWINGS

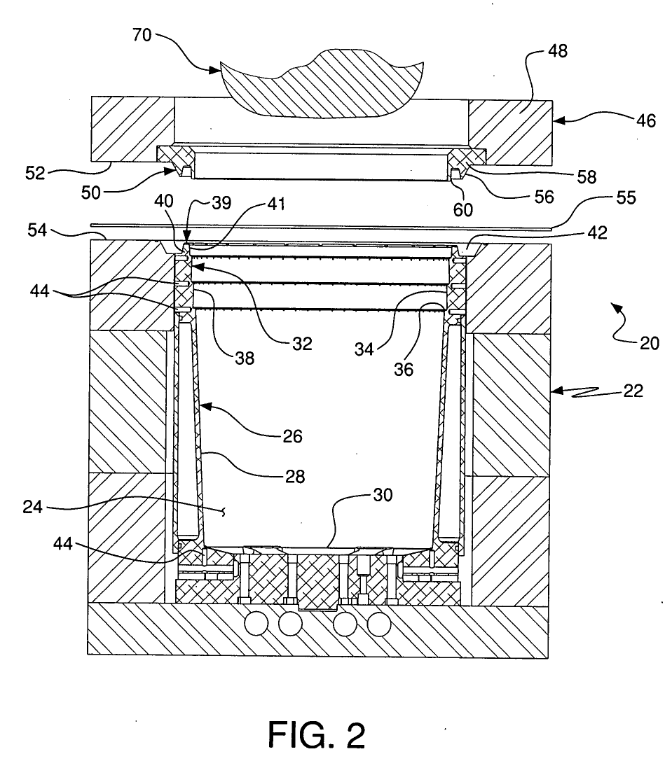

Referring to the drawings where similar reference numerals indicate similar components throughout the views, one preferred embodiment of the invention is shown. FIGS. 2-6 illustrate the stages of a thermoforming process according to the present invention for forming an improved rim on a thermoformed container.

Referring first to FIG. 2, a portion of a mold assembly 20 is shown. The mold assembly 20 is part of a conventional thermoforming mold apparatus (not shown). Such apparatus include various components, such as a feed mechanism for feeding plastic sheets to the mold assembly, and an actuation system for controlling the opening and closing of the molds and movement of the plug assist. Thermoforming mold apparatus are well known in the art and therefore no further discussion is necessary. The mold assembly 20 includes a lower mold 22 defining an inner cavity 24. The lower mold has an inner surface 26 with a contour that defines the outside or exterior surface of a substantial portion of the finished container. In one preferred configuration, the inner surface 26 has a tapered cylindrical or frustoconical side contour 28, is open at the top and includes a bottom or base 30. The base may be substantially flat or may include contours.

The inner surface 26 also includes an upper rim section 32 that includes at least one and, more preferably, a plurality of steps 34 that are characterized by increases in the diameter of the side contour. As shown in the figures, the steps 34 include defined substantially horizontal ledges 36 that extend radially outward, and vertical walls 38 that preferably taper outward slightly (i.e., the diameter of the surface increases radially) as the wall extends upward to a top end 39 which includes an upwardly projecting upper ring 40.

The lower mold 22 also includes a moat or recess 42, which is formed radially outward from the upper ring 40 and is configured to interact with a coining ring as will be discussed in more detail below.

The lower mold 22 includes a series of vacuum channels 44 that communicate between the inner cavity 24 and a negative pressure (vacuum) source (not shown) in a conventional manner. A temperature control system (not shown) may be included for controlling the heating and/or cooling of the lower mold.

As shown in FIG. 2, the lower mold 22 may be made from multiple component portions or segments that are assembled to form the final mold configuration.

The mold assembly 20 also includes an upper mold 46. The upper mold 46 includes a clamp plate 48 and a coining ring 50. The clamp plate 48 is generally similar to conventional clamp plates and includes a clamping surface 52 preferably configured to seal down upon a sheet 55 of plastic material being molded so as to sandwich the sheet between the clamping surface 52 and the lower mold upper surface 54.

The coining ring 50 includes an outer sealing ring 56 which extends down from a main frame portion 58. Referring to FIG. 4, the coining ring 50 also includes an inner mold surface 60 which defines the upper lip of the finished container. The inner mold surface 60 in one embodiment includes a recess 62 and an inner ring 64. The inner ring 64 is preferably formed integral to the main frame portion 58 and extends down from the frame in the same general direction as the outer sealing ring 56. The coining ring 50 and clamp plate are configured, when operatively engaged with the lower mold, to provide a suitable spacing between the inner mold surface 60 of the coining ring and the lower mold to form a defined rim, preferably with a substantially uniform thickness as shown in the figures.

An outer surface 66 of the inner ring 64 may include a non-smooth mold contour to form a defined molded shape on the inside surface of the rim or may be smooth to result in a smooth inner surface. Preferably there are indentations 68 formed in the surface that will result in raised ribs or rings on the inside surface of the rim near the top. These ribs or rings provide a frictional surface for positive grasping of the container by a user.

The molding apparatus includes a plug assist 70. The plug assist is conventional and well known in the field of thermoforming. As such, no further discussion is needed.

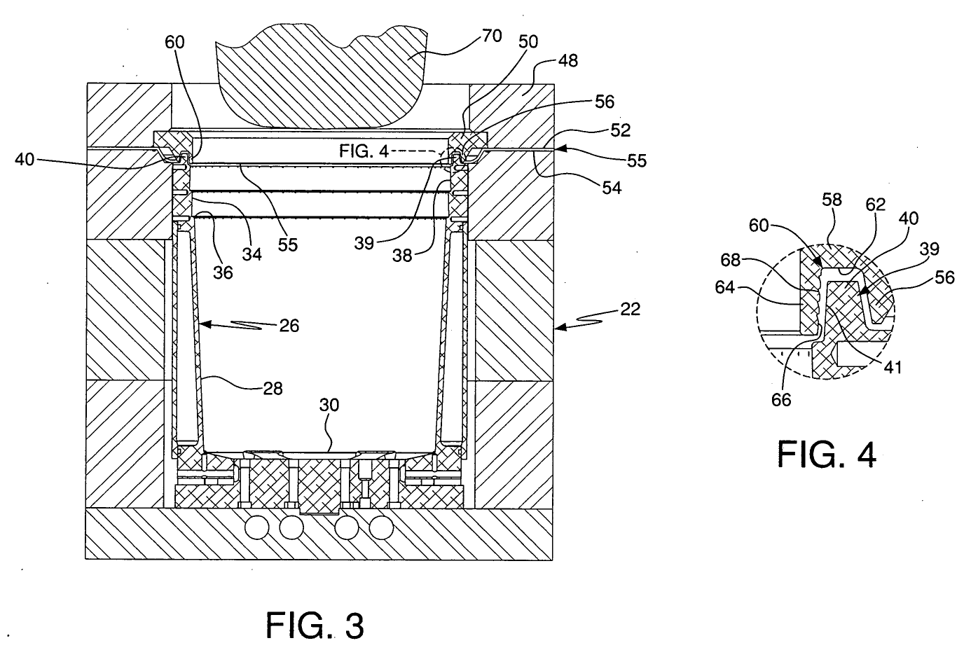

The operation of the molding apparatus for forming the container will now be described with reference to FIGS. 2-6. In the first step of the process, the upper mold 46 is separated from the lower mold 22. A sheet 55 of hot plastic material is placed on or fed over the top or upper surface 54 of the lower mold 22. See FIG. 2. The upper mold 46 is lowered, bringing the clamping surface 52 onto the sheet 55. The lowering of the upper mold 46 brings the coining ring 50 down such that the outer sealing ring 56 engages with the moat 42 in the lower mold 22. The engagement of the outer sealing ring with the moat 42 clamps and seals the sheet between the upper and lower molds. See FIGS. 3 and 4. Although the above discussion describes the lowering of the upper mold onto the lower mold, it should be readily apparent that either or both molds can move without detracting from the present invention. Likewise, although the present embodiment describes a vertically-oriented mold, those of ordinary skill in the art will appreciate that the mold may be oriented in any direction while performing the claimed process.

The inner mold surface 60 is also brought into molding contact with the sheet 55. More specifically, the lowering of the upper mold 46 causes the sheet 55 to be sandwiched and compressed between the upper ring 40 of the lower mold 22 and the recess 62 of the inner mold surface 60, and between the outer surface 66 of the inner ring 64 and the inner surface 41 of the upper ring 40. Thus, the combination of the coining ring 50 and the top end 39 of the lower mold 22 form the molded shape of the top of the rim of the container. Accordingly, this portion of the container is defined entirely by the contour of the molds, and not by air or vacuum pressure. Thus, the thickness and physical characteristics of the rim in this section are well defined.

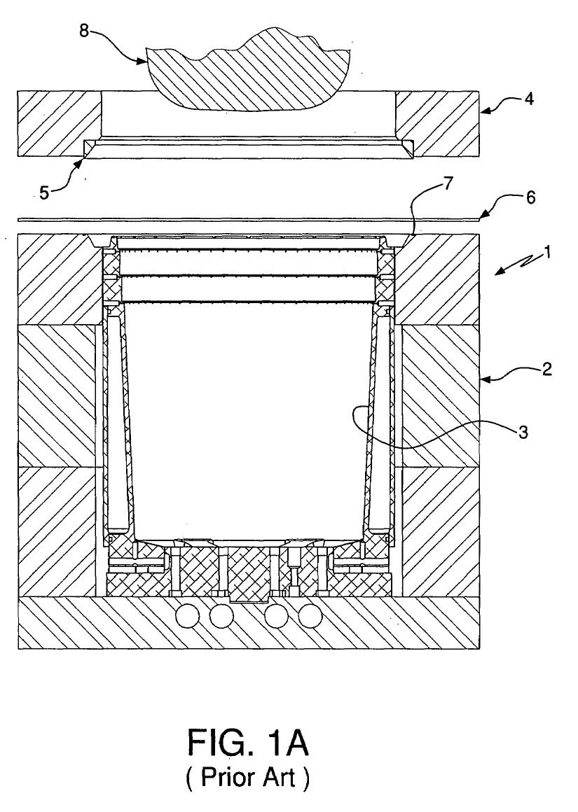

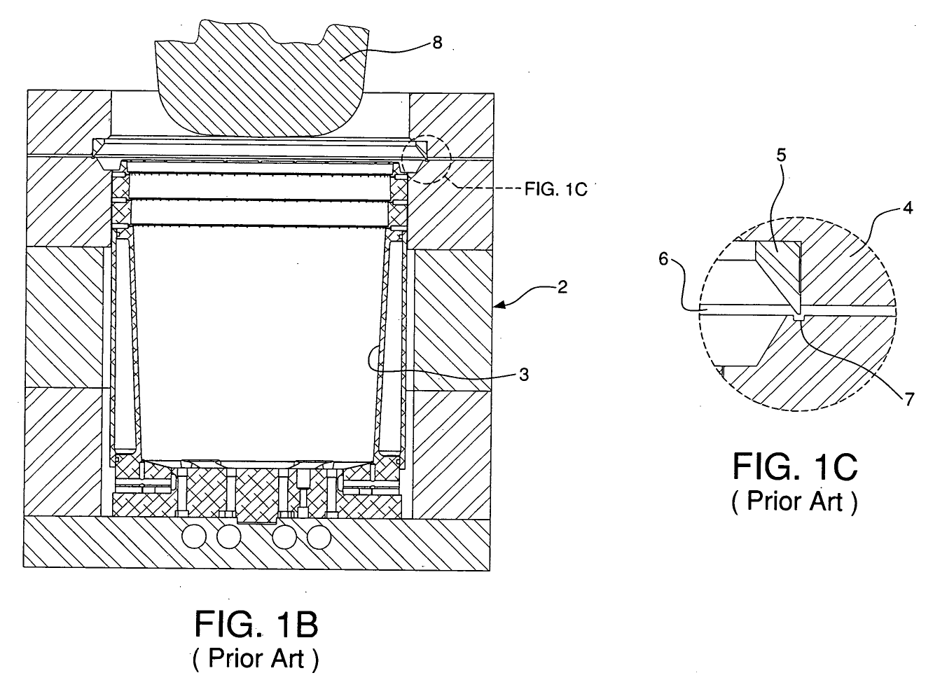

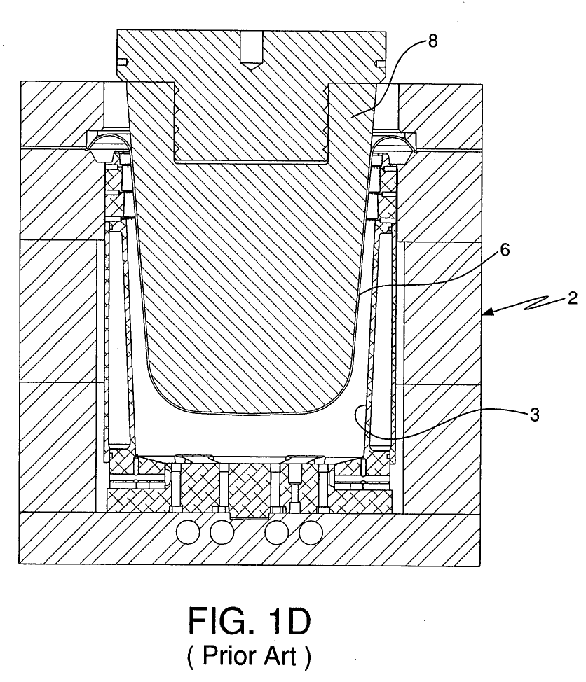

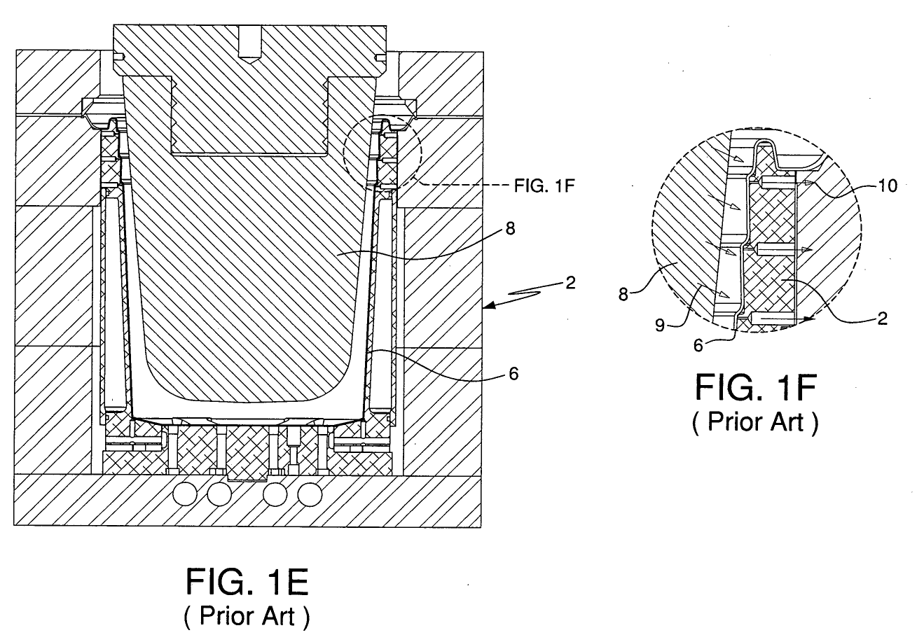

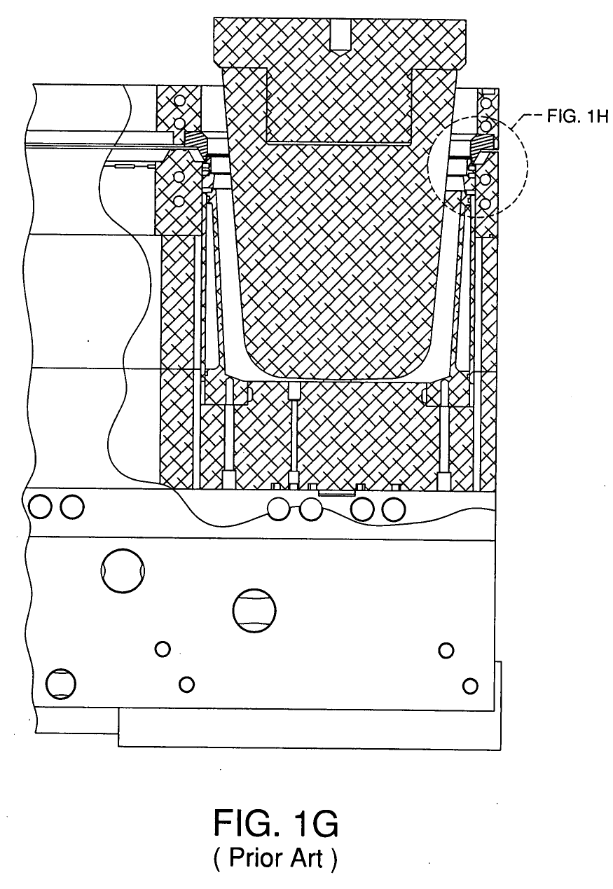

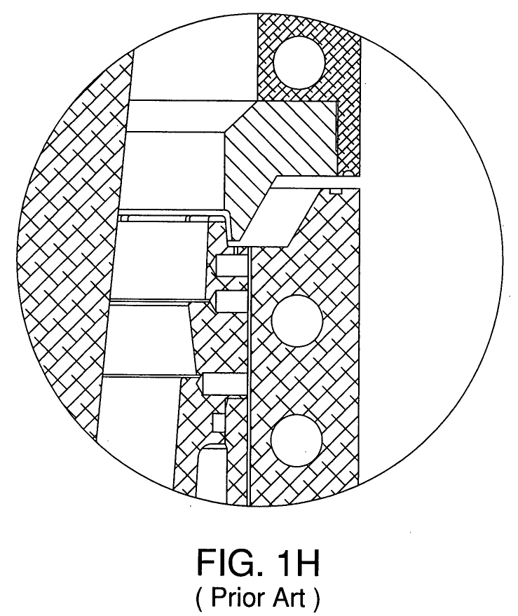

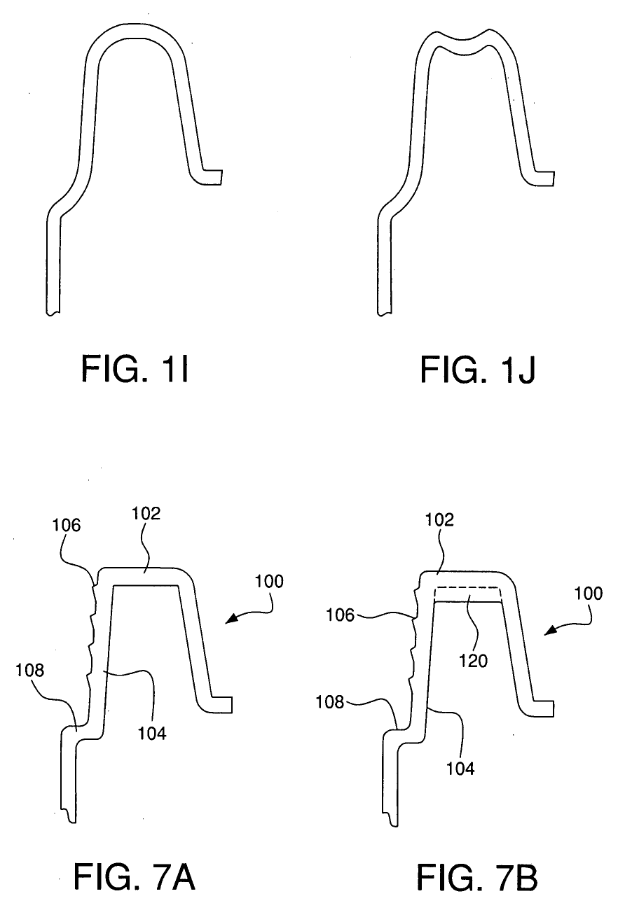

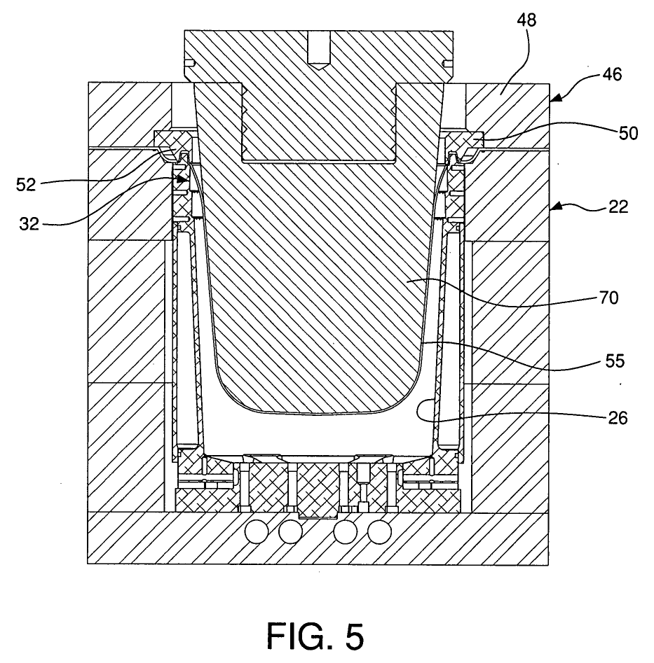

The plug assist 70 is brought down through the upper mold 46 and into contact with the plastic sheet 55. The plug assist mechanically forces the sheet into the lower mold, causing the sheet to stretch. See FIG. 5. As shown, due to the mechanical locking of the sheet between the coining ring 50 and the top end 39 of lower mold 22, the sheet material immediately below the inner ring 64 is positioned closer to the inner surface of the upper section 32 of the lower mold 22, than would otherwise be the case if no coining ring were used. Compare, for example, FIG. 1D and FIG. 5.

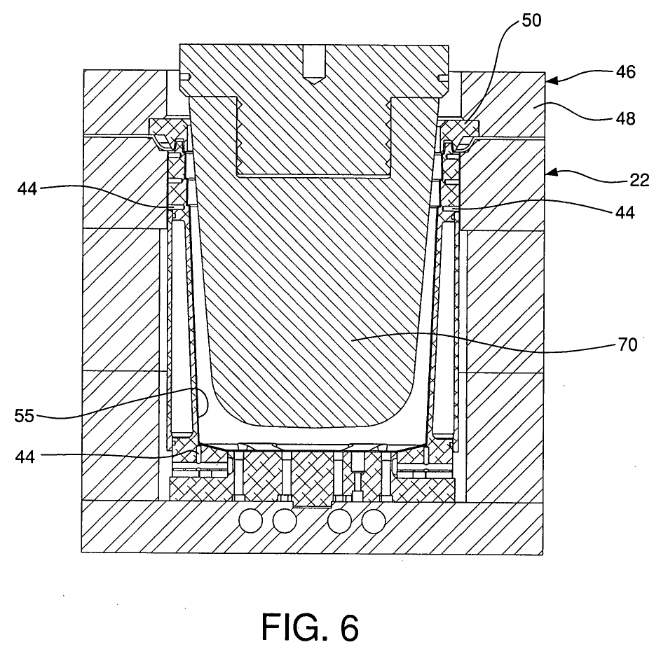

After the plug assist 70 is completely lowered, pressurized air is introduced into inside of the sheet, while a vacuum is drawn on the outside of the sheet in a conventional manner. The combination of the internal pressure and external vacuum draws the plastic sheet into contact with the inner surface 26 of the lower mold 22, finishing the molding of the plastic and permitting it to cool, and thus solidify. See FIG. 6.

In light of the use of the improved coining ring described, the resulting container has a well defined container rim. FIG. 7A illustrates a cross-section of the container rim 100 that results from the use of a coining ring in the present invention. The rim 100 includes a well defined upper ledge 102 with a radially inner wall 104 that has a contour or surface characteristics that result from the interaction of the outer surface 66 of the inner ring 64 and the inner surface 41 of the upper ring 40. Specifically, in the illustrated embodiment, one or more rings 106 protrude radially inward from the inner wall 104. The rings are molded into the container due to the indentations 68 in the outer surface 66 of the inner ring 64. These rings provide a highly beneficial frictional surface when the user attempts to pick up a container with his or her fingers positioned on the inside. In a conventional thermoformed container, the inner surface is too smooth to provide sufficient friction and, thus, the containers are more difficult to grasp with one hand. The rings 106 also add further rigidity to the container by stiffening the rim of the container.

The improved coining ring described above in a thermoforming process results in a thermoformed container that has tight, well formed corners, especially at the top of the container. The squared corners result in a rim design that is stiffer than conventional rims. A further benefit of the well defined corners is the improved ability of the containers to nest when stacked. The upper horizontal ledge 108 is well defined, thereby providing a good support for a container that is nested into it.

A comparison of FIGS. 1I and 7A illustrates the different rims that result from a conventional thermoforming process and the improved thermoforming process of the present invention with the unique coining ring described above.

FIG. 7B illustrates a cross-section taken through a section of the rim with a molded in stiffener. Another benefit provided by the use of the improved coining ring described above is the ability to capture the plastic sheet on both sides of the upper edge of the lower mold. This permits the lower mold to also include molded in recesses for forming stiffeners or ribs 120 in the final rim below the upper ledge 102. This helps stiffen the rim, thus assisting to maintain the container in a round shape during use and to provide a secure rim for carrying. If the lower mold in the conventional molding process were to include a recess, the result would be that the stretching of the material during forming would generate a deep sink in the top or upper ledge of the container rim (see FIG. 1J.

What is claimed is:

1. A thermoforming method for making a nursery container having a well-defined lip, the container having a closed bottom, substantially cylindrical or frustoconical side, an open top, and a rim circumscribing the open top, the rim having an upper ledge with an upper surface and a lower surface, and a radially inner wall that is contiguous with and formed integral to the container side and the upper ledge, the inner wall having an inner surface and an outer surface, the thermoforming method comprising the steps of:
providing a mold assembly including:
an upper mold having a coining ring and a lower surface, the coining ring having a contour that defines the upper surface of the upper ledge of the rim and at least a portion of the inner surface of the inner wall, and
a lower mold having a top surface and an inner mold surface, the top surface of the lower mold defining the lower surface of the upper ledge and the inner surface of the lower mold defining the outer contour of the side of the container and the outer surface of the inner wall of the rim, the inner mold surface defining an inner cavity within the lower mold;
separating the upper mold from the lower mold;
locating a sheet of plastic material between the upper and lower molds, the plastic sheet having a top and a bottom surface;
bringing the upper and lower molds into contact with the plastic sheet so that the coining ring on the upper mold presses the plastic sheet into a recess in the top surface of the lower mold and clamps the plastic sheet between the upper and lower molds, such that the rim of the container is formed by the coining ring and the lower mold;
bringing a plug assist through the upper mold and into contact with the top surface of a portion of the plastic sheet, so as to mechanically force a portion of the plastic sheet to stretch and extend into the lower mold's inner cavity;
introducing pressurized air against the top surface of a portion of the plastic sheet, while introducing vacuum pressure into the cavity between a portion of the bottom surface of the plastic sheet and the inner mold surface of the lower mold, so that a portion of the plastic sheet is forced into contact with the inner mold surface of the lower mold; and
allowing the plastic sheet to cool against the lower mold's inner surface.

2. The method of claim 1, wherein the step of cooling comprises the step of controlling the temperature of the lower mold's inner surface so as to cause the plastic to cool at a desired rate.

3. The method of claim 1, wherein the step of clamping the upper and lower molds onto the plastic sheet further comprises the step of forming well-defined edges on the rim.

4. The method of claim 3, wherein the clamping step further comprises the step of forming circumferential ridges on the inner surface of the rim's inner wall.

5. The method of claim 3, wherein the clamping step further comprises the step of forming at least one radially-oriented stiffening rib below the rim's upper ledge.

6. A nursery container produced by the thermoforming method of claim 1, the container comprising:
a closed bottom;
substantially cylindrical sides;
an open top; and
a rim circumscribing the open top, the rim having a well-defined upper ledge having an upper surface and a lower surface, the rim also having a radially inner wall that is contiguous with and formed integral to the container side and rim upper ledge, the inner wall having an inner surface and an outer surface, the surfaces of the upper ledge and inner wall having contours defined by direct contact with the mold surfaces.

7. The container of claim 6, wherein:
the bottom is contoured;
the sides are tapered cylindrical or frusto-conical; and
the rim's upper ledge is horizontal.

8. The container of claim 6, wherein the rim's inner wall includes at least one circumferential molded ridge.

9. The container of claim 6, wherein the rim includes at least one radially-oriented stiffening rib located on the lower surface of the upper ledge.

10. A nursery container formed by the thermoforming steps of:
providing a mold assembly including:
an upper mold having a coining ring and a lower surface, the coining ring having a contour that defines the upper surface of the upper ledge of the rim and at least a portion of the inner surface of the inner wall, and
a lower mold having a top surface and an inner mold surface, the top surface of the lower mold defining the lower surface of the upper ledge and the inner surface of the lower mold defining the outer contour of the side of the container and the outer surface of the inner wall of the rim, the inner mold surface defining an inner cavity within the lower mold;
separating the upper mold from the lower mold;
inserting a sheet of plastic material between the upper and lower molds, the plastic sheet having a top and a bottom surface;
bringing the upper and lower molds into contact with the plastic sheet so that the coining ring on the upper mold presses the plastic sheet into a recess in the top surface of the lower mold and clamps the plastic sheet between the upper and lower molds, such that the rim of the container is formed by the coining ring and the lower mold;
bringing a plug assist through the upper mold and into contact with the top surface of a portion of the plastic sheet, so as to mechanically force a portion of the plastic sheet to stretch and extend into the lower mold's inner cavity;
introducing pressurized air against the top surface of a portion of the plastic sheet, while introducing vacuum pressure into the cavity between a portion of the bottom surface of the plastic sheet and the inner mold surface of the lower mold, so that a portion of the plastic sheet is forced into contact with the inner mold surface of the lower mold; and
allowing the plastic sheet to cool against the lower mold's inner surface,
the container comprising:
a closed bottom;
substantially cylindrical sides;
an open top; and
a rim circumscribing the open top, the rim having a well-defined upper ledge and a radially inner wall, the rim having a surface with contours formed by the compressing of the plastic sheet between the upper and lower mold surfaces.
